(19) United States
(12) Patent Application Publication
(10) Pub. No.: US 2026/0158637 A1
(43) Pub. Date: Jun. 11, 2026

(54) DETACHABLE HANDLE DEVICE OF FALL ARREST DEVICE

(71) Applicant: YOKE INDUSTRIAL CORP., Taichung City (TW)

(72) Inventors: WEI-CHIEH HUNG, Taichung City (TW); CHIA-HSIEN WANG, Taichung City (TW); TZU-LUN WENG, Taichung City (TW)

(73) Assignee: YOKE INDUSTRIAL CORP., Taichung City (TW)

(21) Appl. No.: 18/969,272

(22) Filed: Dec. 5, 2024

(51) Int. Cl. B25G 3/00

(52) U.S. Cl. CPC B25G 3/00

(57) ABSTRACT

A detachable handle device of a fall arrest device includes a casing and a handle. A mounting space is provided in the casing for accommodating a fall arrest body. The casing includes two half casings detachably engaged with each other and having two handle seats to be joined. Each handle seat forms a fixing rod and a handle recess. Two end portions of the fixing rods are joined. The handle recesses are joined to form a handle hole. The handle has a grip and a connecting rod connected to the grip and has a connecting portion. The connecting portion passes through the handle hole and has a through hole. The fixing rods are inserted into two sides of the through hole and the end portions are located in the through hole. In this way, the handle is detachably engaged with the casing for a user to hold.

### BACKGROUND OF THE INVENTION

### Technical Field

The present invention relates generally to a fall arrest device, and more particularly to a detachable handle device of a fall arrest device.

### Description of Related Art

When a conventional fall arrest device is used, a casing is fixed to a place, and an end of a rope passing out of the casing is engaged with a wearable harness on a user. When the user wearing the wearable harness falls from height, a rotating drum in the fall arrest device rotates quickly by pulling the rope. At that time, a braking assembly of the rotating drum is engaged with a braking device fixed in the casing to stop the rotating drum from continuously rotating and releasing the rope, so that the user could be prevented from continuously falling, thereby ensuring the safety.

A handle is typically formed on the casing of the conventional fall arrest device, so that the user could hold the handle and hence the fall arrest device could be carried conveniently. However, the handle of the conventional fall arrest device is usually integrally formed on the casing. When the handle is required to be replaced with other handles in different shapes or some fall arrest devices do not require a handle, the configuration of the handle could be changed only by replacing the casing or providing the casing without the handle. As a result, the mounting of the handle lacks flexibility, so that manufacturers or the user could not conveniently replace the handle on the casing or provide the casing without the handle.

### BRIEF SUMMARY OF THE INVENTION

In view of the above, the primary objective of the present invention is to provide a handle that is detachably disposed on a casing, wherein the handle is detachable relative to the casing, so that the manufacturer or the user could conveniently replace the handle on the casing with other handles in different shapes or remove the handle from the casing, thereby facilitating the use of the casing.

The present invention provides a detachable handle device of a fall arrest device including a casing and a handle. The casing has a rope exit and includes two half casings. The two half casings are detachably engaged with each other. A mounting space is formed in the two half casings. The rope exit communicates with the mounting space. A side of each of the two half casings has a handle seat. The two handle seats of the two half casings are joined. A side of the handle seat of each of the two half casings close to the mounting space forms a fixing rod. Another side of the handle seat of each of the two half casings away from the mounting space forms a handle recess. The fixing rod of each of the two half casings has a free end. The two free ends of the two fixing rods of the two half casings are joined to abut against each other. The two handle recesses of the two half casings are joined to form a handle hole. The handle includes a grip and a connecting rod. The grip is for a user to hold. The connecting rod is connected to the grip and has a connecting portion. The connecting portion passes through the handle hole and has a through hole. The two fixing rods of the two half casings are inserted into two sides of the through hole of the handle, the two free ends of the two fixing rods of the two half casings are located in the through hole of the handle.

When the detachable handle device is assembled to form a fall arrest device, a fall arrest body is disposed in the mounting space of the casing, and a rope of the fall arrest body passes through the rope exit to extend outward. With the aforementioned design, the two half casings of the casing are separated, so that the handle could be withdrawn from the casing, and then handles with different configurations could be mounted between the two handle seats. Alternatively, after the two half casings of the casing are disengaged and the handle is withdrawn, the two half casings are directly engaged with each other, so that the casing is provided without the handle. As the handle is detachable relative to the casing, the manufacturer and the user could use the detachable handle device conveniently.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the detachable handle device of the fall arrest device according to an embodiment of the present invention;

FIG. 2 is a perspective view of the detachable handle device of the fall arrest device according to the embodiment of the present invention seen from another direction;

FIG. 3 is an exploded view of the detachable handle device of the fall arrest device according to the embodiment of the present invention;

FIG. 3A is a partially enlarged view of a marked region 3A in FIG. 3;

FIG. 3B is a partially enlarged view of a marked region 3B in FIG. 3;

FIG. 4 is a top view of the detachable handle device of the fall arrest device according to the embodiment of the present invention;

FIG. 5 is a sectional view along the 5-5 line in FIG. 4; and

FIG. 5A is a partially enlarged view of a marked region 5A in FIG. 5.

### DETAILED DESCRIPTION OF THE INVENTION

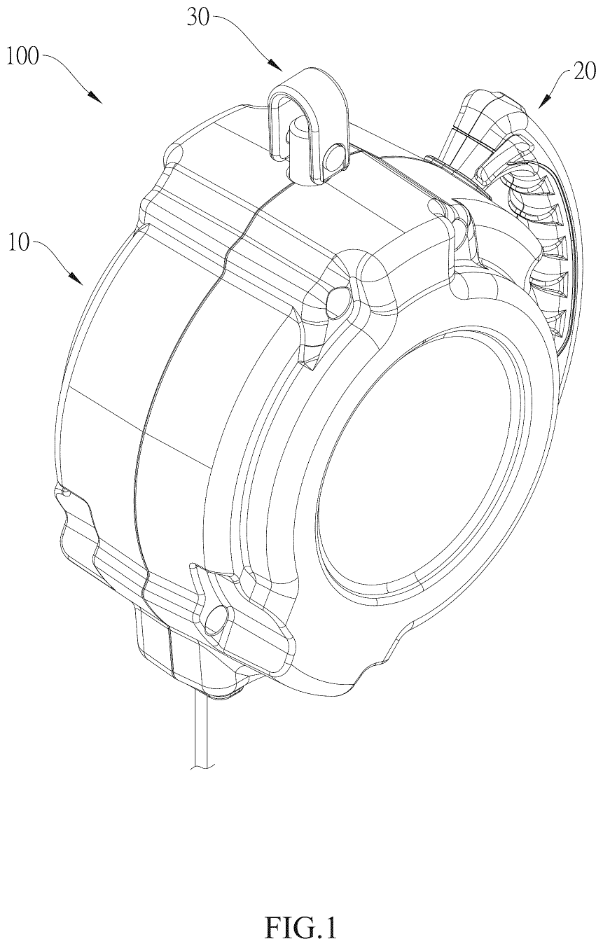

A detachable handle device 100 of a fall arrest device according to an embodiment of the present invention is illustrated in FIG. 1 to FIG. 3B and includes a casing 10 and a handle 20. The casing 10 is adapted to accommodate a fall arrest body 30. Regarding to an orientation of the casing 10 and the fall arrest body 30 when hanging during use, two sides of the casing 10 in a top-bottom direction are defined as a top side and a bottom side, respectively; two sides of the casing 10 in a left-right direction are defined as a left side and a right side, respectively; two sides of the casing 10 in a front-rear direction are defined as a front side and a rear side, respectively.

The casing 10 includes two half casings 10A and has a mounting space S in the casing 10. The fall arrest body 30 is disposed in the mounting space S and has a rope 32. Each of the half casings 10A has a side wall 12 and a peripheral wall 14 connected to a periphery of the side wall 12. The two side walls 12 of the two half casings 10A face each other. In the current embodiment, the side wall 12 of each of the half casings 10A is a circular plate; the peripheral wall 14 of each of the half casings 10A substantially surrounds the side wall 12 to be in a circular shape. Four pairs of through holes 16 are formed between the two peripheral walls 14 of the two half casings 10A. The four pairs of through holes 16 are arranged by regular intervals around the two side walls 12. Four bolt and nut assemblies 161 pass through the four pairs of through holes 16, respectively, so that the two half casings 10A are engaged with each other by screwing. In this way, the two half casings 10A are detachable relative to each other. In other embodiments, the two half casings 10A could be engaged by hooking or tenoning.

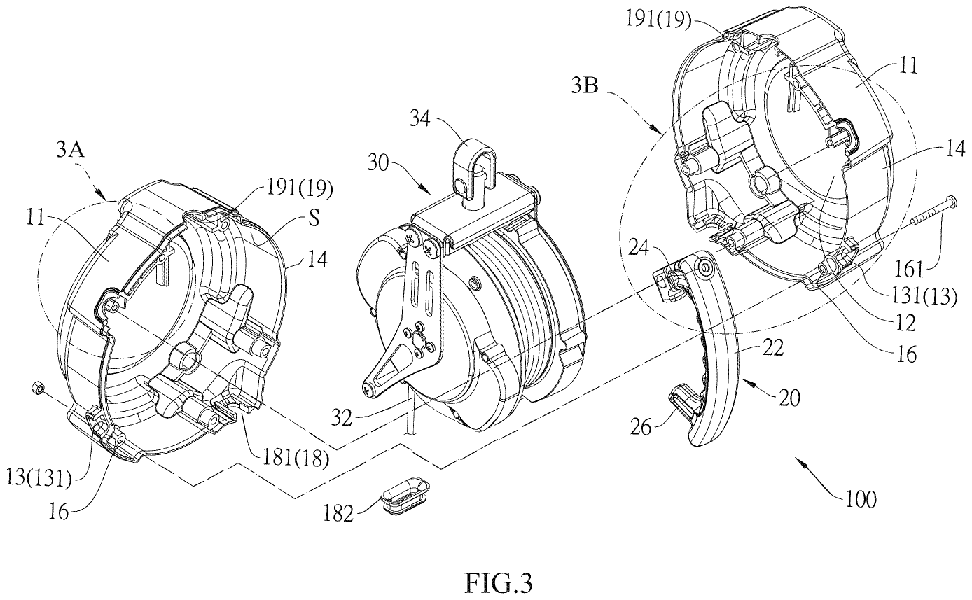

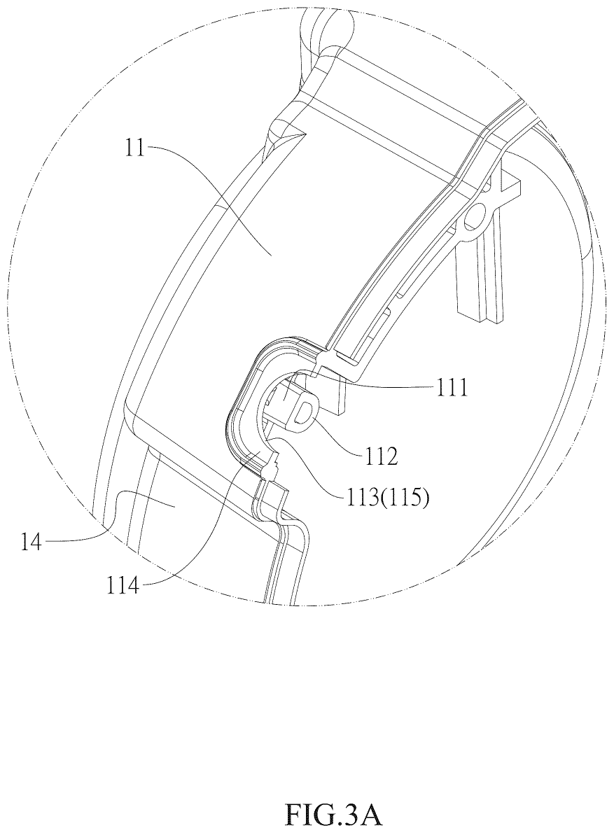

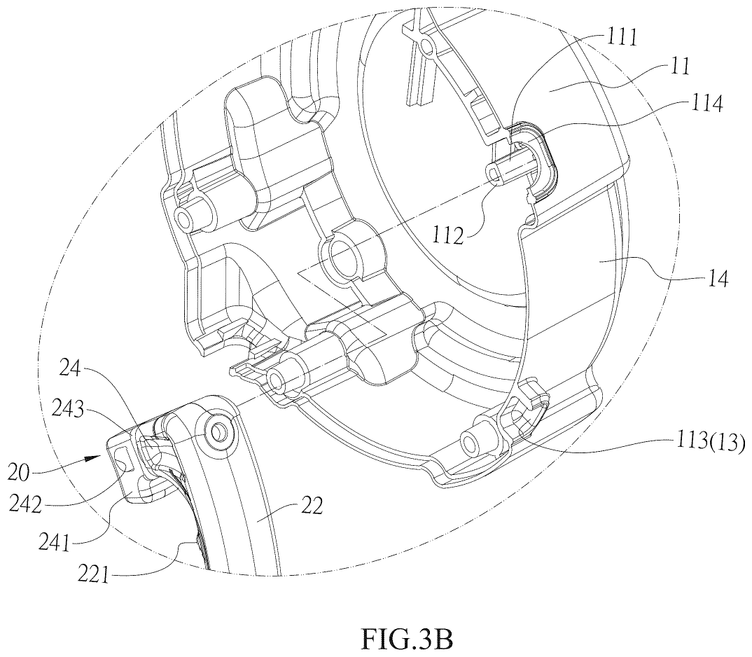

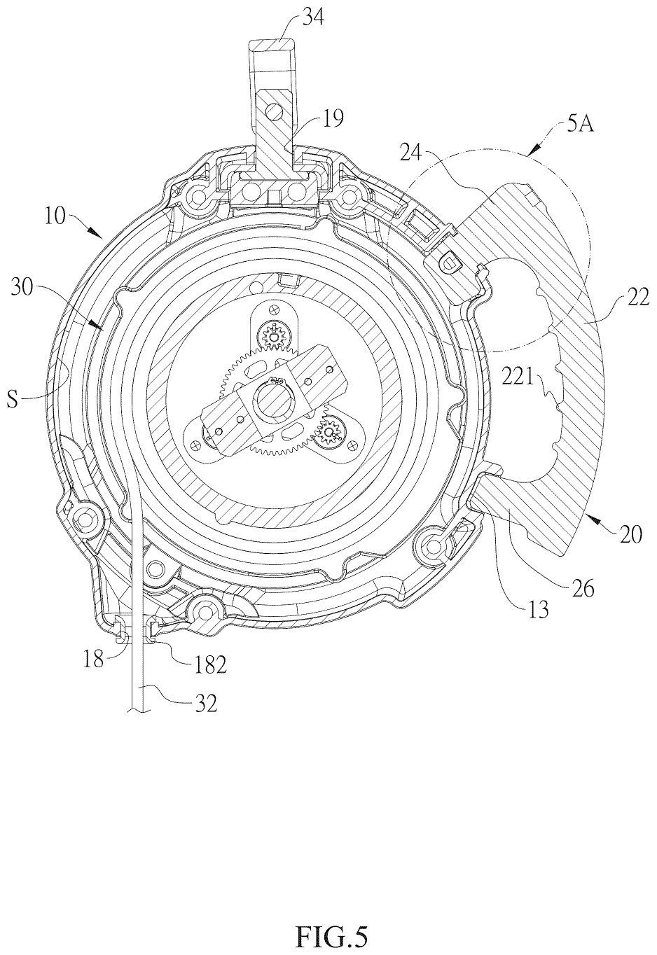

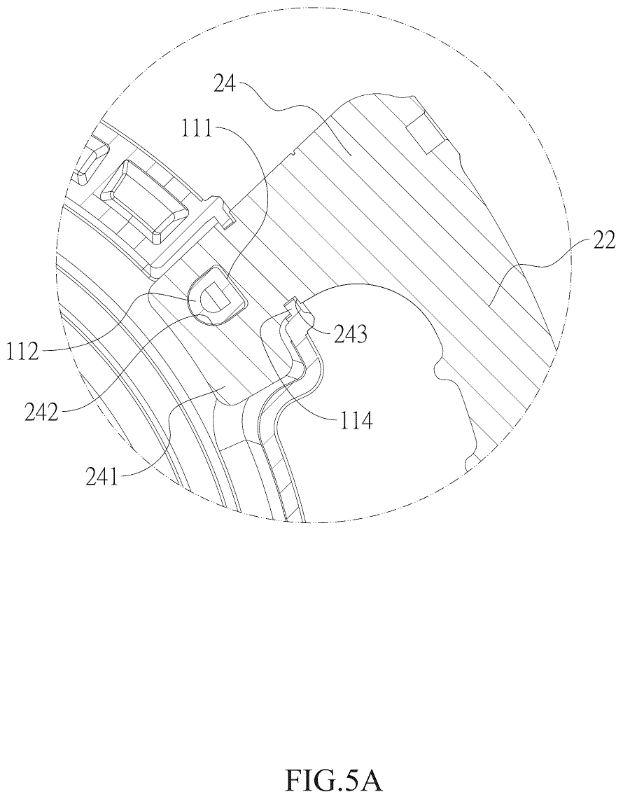

A peripheral edge of a bottom of a front side of the peripheral wall 14 of each of the half casings 10A forms a rope recess 181. The two rope recesses 181 of the two half casings 10A are joined to form a rope exit 18. The rope exit 18 communicates with the mounting space S. A guiding ring 182 is fixed to a peripheral edge of the rope exit 18. Referring to FIG. 3 and FIG. 5, the rope 32 of the fall arrest body 30 passes through an inner side of the guiding ring 182 to extend out of the rope exit 18. A peripheral edge of a top of the peripheral wall 14 of each of the half casings 10A forms a ring recess 191. The two ring recesses 191 of the two half casings 10A are joined to form a ring hole 19. The ring hole 19 communicates with the mounting space S. A top of the fall arrest body 30 has a ring 34. The ring 34 extends outwards from the ring hole 19. The ring 34 is adapted to hang the casing 10 and the fall arrest body 30 in the casing 10 on a fixed place, such as rails of scaffolding, hooks on a wall, etc.

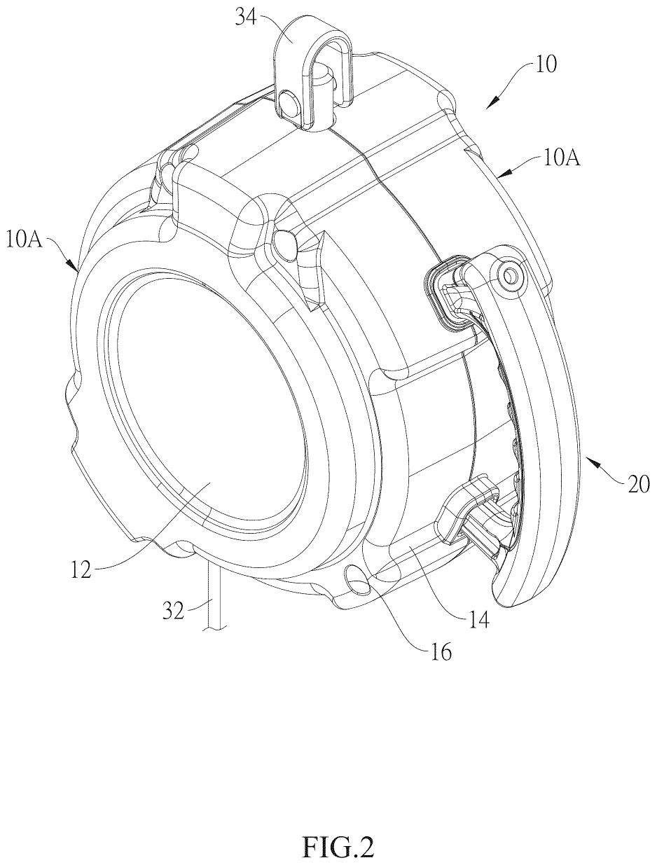

Referring to FIG. 2 to FIG. 3B, a top of a rear side of each of the half casings 10A has a handle seat 11. The two handle seats 11 of the two half casings 10A are joined. A side of the handle seat 11 of each of the half casings 10A close to the mounting space S forms a fixing rod 111. The fixing rod 111 of each of the half casings 10A has a free end 112. The free ends 112 of the two fixing rods 111 are joined to abut against each other. Another side of the handle seat 11 of each of the half casings 10A away from the mounting space S forms a handle recess 113. A peripheral edge of the handle recess 113 of each of the half casings 10A forms a positioning protrusion 114. The two handle recesses 113 of the two half casings 10A are joined to form a handle hole 115. An outer surface of a bottom of the rear side of each of the half casings 10A has a half slot 131. The half slot 131 is connected to a peripheral edge of the peripheral wall 14. The two half slots 131 of the two half casings 10A are joined to form a slot 13. More specifically, the slot 13 is a rectangular recess.

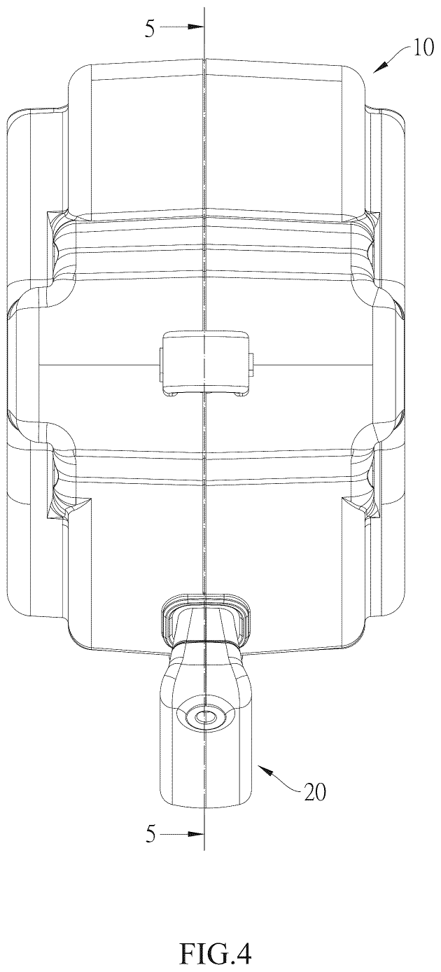

The handle 20 includes a grip 22, a connecting rod 24, and an insertion rod 26. Referring to FIG. 3B to FIG. 5A, the grip 22 is an arced rod body and is provided with a plurality of anti-slip strips 221 on a side of the grip 22 facing the casing 10 for a user to hold. The connecting rod 24 is connected to a top end of the grip 22 and has a connecting portion 241. The connecting portion 241 passes through the handle hole 115. A part of the connecting portion 241 inserted into the handle hole 115 has a through hole 242. A periphery of the part of the connecting portion 241 passing through the handle hole 115 forms a positioned groove 243. The two positioning protrusions 114 of the two half casings 10A fit into two sides of the positioned groove 243 for fixing. The two fixing rods 111 of the two half casings 10A are inserted into two sides of the through hole 242, and the two free ends 112 of the two fixing rods 111 are located in the through hole 242. The insertion rod 26 is connected to a bottom end of the grip 22. The insertion rod 26 is inserted into the slot 13 for positioning.

When the handle 20 according to the embodiment of the present invention is about to be replaced with different handles or is about to be removed from the casing 10, firstly each of the bolt and nut assemblies 161 is loosened from each of the pairs of through holes 16; then, the two half casings 10A of the left side and on the right side of the casing 10 are separated. In this way, the handle 20 could be removed from the casing 10. Afterwards, handles with different configurations could be mounted between the two handle seats 11 and then the two half casings 10A are engaged with each other. Alternatively, after the two half casings 10A on the left side and the right side of the casing 10 are disengaged and the handle 20 is withdrawn, the two half casings 10A are directly engaged with each other by screwing, so that the casing 10 form a configuration that is not connected to a handle. In the embodiment, the casing 10 is provided with the slot 13 for inserting and positioning the insertion rod 26 of the handle 20. In other embodiments, the casing 10 could be provided without the slot 13; at that time, the insertion rod 26 only abuts against a surface of the peripheral wall 14 for positioning; alternatively, the handle 20 is provided without the insertion rod 26; at that time, the top end of the grip 22 is connected to the connecting rod 24 and the bottom end of the grip 22 is suspended.

In the embodiment, the top end of the grip 22 of the handle 20 is connected to the connecting rod 24 and the bottom end of the grip 22 is connected to the insertion rod 26. In other embodiments, the insertion rod 26 could be omitted and the grip 22 is provided as an annular body or a straight grip, wherein a middle of the grip 22 is connected to the connecting rod 24 and the connecting portion 241 of the connecting rod 24 is connected to the two handle seats 11. Moreover, in the embodiment, the tow handle seats 11 and the slot 13 are formed on the top and the bottom of the rear side of the casing 10, respectively. In other embodiments, the two handle seats 11 and the slot 13 could be formed and arranged by intervals on either the front side of the casing 10 or the bottom side of the casing 10; then the two handle seats 11 and the slot 13 are detachably engaged with the connecting portion 241 and the insertion rod 26 of the handle 20, respectively.

It must be pointed out that the embodiments described above are only some preferred embodiments of the present invention. All equivalent structures which employ the concepts disclosed in this specification and the appended claims should fall within the scope of the present invention.

What is claimed is:

1. A detachable handle device of a fall arrest device, comprising:
a casing having a rope exit and comprising two half casings, wherein the two half casings are detachably engaged with each other; a mounting space is formed in the two half casings; the rope exit communicates with the mounting space; a side of each of the two half casings has a handle seat; the two handle seats of the two half casings are joined; a side of the handle seat of each of the two half casings close to the mounting space forms a fixing rod; another side of the handle seat of each of the two half casings away from the mounting space forms a handle recess; the fixing rod of each of the two half casings has a free end; the two free ends of the two fixing rods of the two half casings are joined to abut against each other; the two handle recesses of the two half casings are joined to form a handle hole; and
a handle comprising a grip and a connecting rod, wherein the grip is for a user to hold; the connecting rod is connected to the grip and has a connecting portion; the connecting portion passes through the handle hole and has a through hole; the two fixing rods of the two half casings are inserted into two sides of the through hole of the handle, and the two free ends of the two fixing rods of the two half casings are located in the through hole of the handle.

2. The detachable handle device as claimed in claim 1, wherein another side of each of the two half casings has a rope recess; the two rope recesses of the two half casings are joined to form the rope exit.

3. The detachable handle device as claimed in claim 2, wherein an outer surface of each of the two half casings has a half slot; the two half slots of the two half casings are joined to form a slot; the connecting rod is connected to an end of the grip; another end of the grip is connected to an insertion rod; the insertion rod is inserted into the slot for positioning.

4. The detachable handle device as claimed in claim 3, wherein a peripheral edge of the handle recess of each of the two half casings forms a positioning protrusion; a positioned groove is provided on a periphery of the connecting portion; the two positioning protrusions of the two half casings fit into two sides of the positioned groove for fixing.

5. The detachable handle device as claimed in claim 4, wherein each of the two half casings has a side wall and a peripheral wall connected to the side wall; the handle seat is formed on the peripheral wall; the rope recess is formed on a peripheral edge of the peripheral wall; the half slot is connected to the peripheral edge of the peripheral wall.

6. The detachable handle device as claimed in claim 5, wherein the peripheral wall is circular; the grip of the handle is an arced rod body; a side of the grip facing the casing is provided with a plurality of anti-slip strips.

7. The detachable handle device as claimed in claim 6, wherein a plurality of pairs of through holes is formed between the two peripheral walls of the two half casings; the plurality of pairs of through holes of the two half casings are disposed around the two side walls of the two half casings and are arranged by intervals; a plurality of bolt and nut assemblies passes through the plurality of pairs of through holes of the two half casings, thereby engaging the two half casings by screwing.
